(19) United States
(12) Patent Application Publication
(10) Pub. No.: US 2026/0247375 A1
(43) Pub. Date: Aug. 20, 2026

(54) FEEDBACK TECHNIQUES FOR UNSCHEDULED CARRIERS IN WIRELESS COMMUNICATIONS

(71) Applicant: QUALCOMM Incorporated, San Diego, CA (US)

(72) Inventors: Diana MAAMARI, San Diego, CA (US); Mostafa KHOSHNEVISAN, San Diego, CA (US); Gabi SARKIS, San Diego, CA (US); Kianoush HOSSEINI, San Diego, CA (US)

(21) Appl. No.: 19/053,768

(22) Filed: Feb. 14, 2025

(51) Int. Cl. H04W 72/1273; H04W 72/0446; H04W 72/0453

(52) U.S. Cl. CPC H04W 72/1273; H04W 72/0446; H04W 72/0453

(57) ABSTRACT

Methods, systems, and devices for wireless communications are described that provide for activation of a set of component carriers (CCs) at a user equipment (UE), and for configuration of a first codebook size for providing feedback associated with downlink communications via the set of CCs. The UE may receive control information that indicates at least a first CC of the set of CCs will be unscheduled for communications during a first set of slots. Based on the control information, the UE may monitor for one or more downlink communications via remaining CCs of the set of CCs. The UE may format a feedback codebook that includes feedback information associated with the one or more downlink communications, where the feedback codebook has a second codebook size that is based on the number of carriers of the remaining CCs, and that is different than the first codebook size.

### FIELD OF TECHNOLOGY

The following relates to wireless communications, including feedback techniques for unscheduled carriers in wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving first control information that activates a set of carriers at the UE, and that indicates a feedback configuration associated with the set of carriers, where the set of carriers includes two or more carriers and the feedback configuration indicates a first feedback codebook size associated with a first quantity of carriers of the set of carriers, receiving second control information that indicates at least a first carrier of the set of carriers will be unscheduled for communications during at least a first time period, monitoring for one or more downlink communications via a subset of the set of carriers that are schedulable for communications during at least the first time period in accordance with the second control information, where the subset of carriers includes a second quantity of carriers, and transmitting a first feedback codebook that includes first feedback information associated with the one or more downlink communications, where the first feedback codebook has a second codebook size that is based on the second quantity of carriers and that is different than the first codebook size.

A UE for wireless communications is described. The UE may include one or more memories storing processor executable code, and one or more processors coupled with the one or more memories. The one or more processors may individually or collectively be operable to execute the code to cause the UE to receive first control information that activates a set of carriers at the UE, and that indicates a feedback configuration associated with the set of carriers, where the set of carriers includes two or more carriers and the feedback configuration indicates a first feedback codebook size associated with a first quantity of carriers of the set of carriers, receive second control information that indicates at least a first carrier of the set of carriers will be unscheduled for communications during at least a first time period, monitor for one or more downlink communications via a subset of the set of carriers that are schedulable for communications during at least the first time period in accordance with the second control information, where the subset of carriers includes a second quantity of carriers, and transmit a first feedback codebook that includes first feedback information associated with the one or more downlink communications, where the first feedback codebook has a second codebook size that is based on the second quantity of carriers and that is different than the first codebook size.

Another UE for wireless communications is described. The UE may include means for receiving first control information that activates a set of carriers at the UE, and that indicates a feedback configuration associated with the set of carriers, where the set of carriers includes two or more carriers and the feedback configuration indicates a first feedback codebook size associated with a first quantity of carriers of the set of carriers, means for receiving second control information that indicates at least a first carrier of the set of carriers will be unscheduled for communications during at least a first time period, means for monitoring for one or more downlink communications via a subset of the set of carriers that are schedulable for communications during at least the first time period in accordance with the second control information, where the subset of carriers includes a second quantity of carriers, and means for transmitting a first feedback codebook that includes first feedback information associated with the one or more downlink communications, where the first feedback codebook has a second codebook size that is based on the second quantity of carriers and that is different than the first codebook size.

A non-transitory computer-readable medium storing code for wireless communications is described. The code may include instructions executable by one or more processors to receive first control information that activates a set of carriers at the UE, and that indicates a feedback configuration associated with the set of carriers, where the set of carriers includes two or more carriers and the feedback configuration indicates a first feedback codebook size associated with a first quantity of carriers of the set of carriers, receive second control information that indicates at least a first carrier of the set of carriers will be unscheduled for communications during at least a first time period, monitor for one or more downlink communications via a subset of the set of carriers that are schedulable for communications during at least the first time period in accordance with the second control information, where the subset of carriers includes a second quantity of carriers, and transmit a first feedback codebook that includes first feedback information associated with the one or more downlink communications, where the first feedback codebook has a second codebook size that is based on the second quantity of carriers and that is different than the first codebook size.

In some examples of the method, UEs, and non-transitory computer-readable medium described herein, the receiving the second control information may include operations, features, means, or instructions for receiving radio resource control (RRC) signaling or a medium access control (MAC) control element that indicates that at least the first carrier of the set of carriers will be unscheduled for communications until a subsequent control information transmission provides an indication that at least the first carrier is schedulable.

In some examples of the method, UEs, and non-transitory computer-readable medium described herein, the second codebook size may be based on the second quantity of carriers and a quantity of slots within a feedback time duration indicated in the feedback configuration. In some examples of the method, UEs, and non-transitory computer-readable medium described herein, the feedback configuration indicates a feedback codebook that has a fixed quantity of bits.

In some examples of the method, UEs, and non-transitory computer-readable medium described herein, the first control information further indicates a first feedback timing information associated with a quantity of slots between a downlink data slot and an uplink slot that includes feedback information, and the second control information further indicates an update to the first feedback timing information.

In some examples of the method, UEs, and non-transitory computer-readable medium described herein, the first feedback timing information includes a set of downlink-data-to-uplink-acknowledgment values, and the second control information indicates that one or more of the downlink-data-to-uplink-acknowledgment values is not used for determining the first feedback information. In some examples of the method, UEs, and non-transitory computer-readable medium described herein, the first feedback codebook may be transmitted in a first uplink slot and the feedback information may be associated with the one or more downlink communications within a feedback window prior to the first uplink slot, and where the second control information further indicates an update to the feedback window.

In some examples of the method, UEs, and non-transitory computer-readable medium described herein, the first feedback information may be associated with the subset of carriers, and one or more subsequent feedback codebooks include subsequent feedback information associated with a different quantity of carriers than the second quantity of carriers in accordance with subsequent control information that indicates at least the first carrier of the set of carriers is schedulable for communications during a subsequent time period, or that at least a second carrier of the set of carriers will be unscheduled during the subsequent time period.

In some examples of the method, UEs, and non-transitory computer-readable medium described herein, the feedback configuration includes a feedback time window associated with each carrier of the set of carriers, and a feedback time window associated with each carrier of the subset of carriers is based on a set of slots in which a corresponding carrier can be scheduled for downlink communications.

In some examples of the method, UEs, and non-transitory computer-readable medium described herein, the first control information further indicates a first uplink resource for transmission of feedback information that is associated with the set of carriers, and a second uplink resource for transmission of feedback information that is associated with the subset of carriers and the second control information includes an indication of which of the first uplink resource or the second uplink resource is to be used for transmission of the first feedback information.

In some examples of the method, UEs, and non-transitory computer-readable medium described herein, the first control information further indicates a set of multiple frequency segments that are each associated with one or more carriers of the set of carriers, and the second control information indicates a quantity of the set of multiple frequency segments that will be unscheduled for communications during at least the first time period. Some examples of the method, UEs, and non-transitory computer-readable medium described herein may further include operations, features, means, or instructions for bundling feedback information for one or more carriers that are included in a remaining quantity of the set of multiple frequency segments. In some examples of the method, UEs, and non-transitory computer-readable medium described herein, the bundling the feedback information may include operations, features, means, or instructions for including feedback information associated with each slot of a set of downlink slots associated with a single carrier when the single carrier is included in a remaining quantity of the set of multiple frequency segments and encoding feedback information from two or more carriers for each slot of the set of downlink slots when two or more carriers are included in the remaining quantity of the set of multiple frequency segments, where the encoded feedback information indicates feedback information for each of the two or more carriers that are schedulable in the remaining quantity of the set of multiple frequency segments.

A method for wireless communications by a network entity is described. The method may include outputting first control information that activates a set of carriers at a UE, and that indicates a feedback configuration associated with the set of carriers, where the set of carriers includes two or more carriers and the feedback configuration indicates a first feedback codebook size associated with a first quantity of carriers of the set of carriers, outputting second control information that indicates at least a first carrier of the set of carriers will be unscheduled for communications during at least a first time period, outputting for one or more downlink communications via a subset of the set of carriers that are schedulable for communications during at least the first time period in accordance with the second control information, where the subset of carriers includes a second quantity of carriers, and obtaining a first feedback codebook that includes first feedback information associated with the one or more downlink communications, where the first feedback codebook has a second codebook size that is based on the second quantity of carriers and that is different than the first codebook size.

A network entity for wireless communications is described. The network entity may include one or more memories storing processor executable code, and one or more processors coupled with the one or more memories. The one or more processors may individually or collectively be operable to execute the code to cause the network entity to output first control information that activates a set of carriers at a UE, and that indicates a feedback configuration associated with the set of carriers, where the set of carriers includes two or more carriers and the feedback configuration indicates a first feedback codebook size associated with a first quantity of carriers of the set of carriers, output second control information that indicates at least a first carrier of the set of carriers will be unscheduled for communications during at least a first time period, output for one or more downlink communications via a subset of the set of carriers that are schedulable for communications during at least the first time period in accordance with the second control information, where the subset of carriers includes a second quantity of carriers, and obtain a first feedback codebook that includes first feedback information associated with the one or more downlink communications, where the first feedback codebook has a second codebook size that is based on the second quantity of carriers and that is different than the first codebook size.

Another network entity for wireless communications is described. The network entity may include means for outputting first control information that activates a set of carriers at a UE, and that indicates a feedback configuration associated with the set of carriers, where the set of carriers includes two or more carriers and the feedback configuration indicates a first feedback codebook size associated with a first quantity of carriers of the set of carriers, means for outputting second control information that indicates at least a first carrier of the set of carriers will be unscheduled for communications during at least a first time period, means for outputting for one or more downlink communications via a subset of the set of carriers that are schedulable for communications during at least the first time period in accordance with the second control information, where the subset of carriers includes a second quantity of carriers, and means for obtaining a first feedback codebook that includes first feedback information associated with the one or more downlink communications, where the first feedback codebook has a second codebook size that is based on the second quantity of carriers and that is different than the first codebook size.

A non-transitory computer-readable medium storing code for wireless communications is described. The code may include instructions executable by one or more processors to output first control information that activates a set of carriers at a UE, and that indicates a feedback configuration associated with the set of carriers, where the set of carriers includes two or more carriers and the feedback configuration indicates a first feedback codebook size associated with a first quantity of carriers of the set of carriers, output second control information that indicates at least a first carrier of the set of carriers will be unscheduled for communications during at least a first time period, output for one or more downlink communications via a subset of the set of carriers that are schedulable for communications during at least the first time period in accordance with the second control information, where the subset of carriers includes a second quantity of carriers, and obtain a first feedback codebook that includes first feedback information associated with the one or more downlink communications, where the first feedback codebook has a second codebook size that is based on the second quantity of carriers and that is different than the first codebook size.

In some examples of the method, network entities, and non-transitory computer-readable medium described herein, the outputting the second control information may include operations, features, means, or instructions for outputting RRC signaling or a MAC control element that indicates that at least the first carrier of the set of carriers will be unscheduled for communications until a subsequent control information transmission provides an indication that at least the first carrier is schedulable. In some examples of the method, network entities, and non-transitory computer-readable medium described herein, the second codebook size may be based on the second quantity of carriers and a quantity of slots within a feedback time duration indicated in the feedback configuration. In some examples of the method, network entities, and non-transitory computer-readable medium described herein, the feedback configuration indicates a feedback codebook that has a fixed quantity of bits.

In some examples of the method, network entities, and non-transitory computer-readable medium described herein, the first control information further indicates a first feedback timing information associated with a quantity of slots between a downlink data slot and an uplink slot that includes feedback information, and the second control information further indicates an update to the first feedback timing information. In some examples of the method, network entities, and non-transitory computer-readable medium described herein, the first feedback timing information includes a set of downlink-data-to-uplink-acknowledgment values, and the second control information indicates that one or more of the downlink-data-to-uplink-acknowledgment values are not used for determining the first feedback information.

In some examples of the method, network entities, and non-transitory computer-readable medium described herein, the first feedback codebook may be provided in a first uplink slot and the feedback information may be associated with the one or more downlink communications within a feedback window prior to the first uplink slot, and where the second control information further indicates an update to the feedback window.

In some examples of the method, network entities, and non-transitory computer-readable medium described herein, the first feedback information may be associated with the subset of carriers, and one or more subsequent feedback codebooks include subsequent feedback information associated with a different quantity of carriers than the second quantity of carriers in accordance with subsequent control information that indicates at least the first carrier of the set of carriers is schedulable for communications during a subsequent time period, or that at least a second carrier of the set of carriers will be unscheduled during the subsequent time period.

In some examples of the method, network entities, and non-transitory computer-readable medium described herein, the feedback configuration includes a feedback time window associated with each carrier of the set of carriers, and a feedback time window associated with each carrier of the subset of carriers is based on a set of slots in which a corresponding carrier can be scheduled for downlink communications.

In some examples of the method, network entities, and non-transitory computer-readable medium described herein, the first control information further indicates a first uplink resource for transmission of feedback information that is associated with the set of carriers, and a second uplink resource for transmission of feedback information that is associated with the subset of carriers and the second control information includes an indication of which of the first uplink resource or the second uplink resource is to be used for transmission of the first feedback information.

In some examples of the method, network entities, and non-transitory computer-readable medium described herein, the first control information further indicates a set of multiple frequency segments that are each associated with one or more carriers of the set of carriers, and the second control information indicates a quantity of the set of multiple frequency segments that will be unscheduled for communications during at least the first time period. In some examples of the method, network entities, and non-transitory computer-readable medium described herein, the first feedback information includes bundled feedback for one or more carriers that are included in a remaining quantity of the set of multiple frequency segments. In some examples of the method, network entities, and non-transitory computer-readable medium described herein, the bundled feedback includes a feedback indication associated with each slot of a set of downlink slots associated with a single carrier when the single carrier is included in a remaining quantity of the set of multiple frequency segments and the bundled feedback includes encoded feedback information from two or more carriers for each slot of the set of downlink slots when two or more carriers are included in the remaining quantity of the set of multiple frequency segments, where the encoded feedback information indicates feedback information for each of the two or more carriers that are schedulable in the remaining quantity of the set of multiple frequency segments.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports feedback techniques for unscheduled carriers in wireless communications in accordance with one or more aspects of the present disclosure.

FIG. 2 shows an example of a wireless communication system that supports feedback techniques for unscheduled carriers in wireless communications in accordance with one or more aspects of the present disclosure.

FIGS. 3 through 6 show examples of feedback configurations for unscheduled carriers in wireless communications in accordance with one or more aspects of the present disclosure.

FIGS. 7 and 8 show block diagrams of devices that support feedback techniques for unscheduled carriers in wireless communications in accordance with one or more aspects of the present disclosure.

FIG. 9 shows a block diagram of a communications manager that supports feedback techniques for unscheduled carriers in wireless communications in accordance with one or more aspects of the present disclosure.

FIG. 10 shows a diagram of a system including a device that supports feedback techniques for unscheduled carriers in wireless communications in accordance with one or more aspects of the present disclosure.

FIGS. 11 and 12 show block diagrams of devices that support feedback techniques for unscheduled carriers in wireless communications in accordance with one or more aspects of the present disclosure.

FIG. 13 shows a block diagram of a communications manager that supports feedback techniques for unscheduled carriers in wireless communications in accordance with one or more aspects of the present disclosure.

FIG. 14 shows a diagram of a system including a device that supports feedback techniques for unscheduled carriers in wireless communications in accordance with one or more aspects of the present disclosure.

FIGS. 15 and 16 show flowcharts illustrating methods that support feedback techniques for unscheduled carriers in wireless communications in accordance with one or more aspects of the present disclosure.

### DETAILED DESCRIPTION

Wireless networks may schedule user equipment (UE) for wideband communications where the UE operates at its higher power level in order to receive the communications via the wide bandwidth. The high-power state includes the UE using a higher clock frequency and generally a higher supply voltage, which may lead to an increase in power consumption by the UE. In such cases, the increase in power consumption may be non-linear (e.g., quadratic) as bandwidth increases. In some examples, the wideband communications may be scheduled in an efficient manner where the UE is scheduled for the wideband communications during a first time period (e.g., a first slot or set of slots) and then the UE is not scheduled for the wideband communications during a second time period (e.g., the next few slot(s)). For example, a UE may have two or more active component carriers (CCs) where a first CC may be a narrowband carrier (e.g., a carrier that occupies a 20 MHz channel bandwidth) and a second CC may be a wideband carrier (e.g., a carrier that occupies 100 MHz channel bandwidth) or a narrowband carrier. In some cases, a UE may be scheduled on the second CC for a first slot or first set of slots, and it may be indicated that a second set of slots will not be scheduled even though the second CC remains an active CC. In such cases, the UE may switch to a lower power level during the second set of slots, such as by reducing a clock frequency and supply voltage based on more relaxed processing timelines that are associated with the narrowband first CC. However, this approach may introduce issues with regards to the hybrid automatic repeat/request (HARQ) feedback of the UE. For example, a HARQ acknowledgment/negative-acknowledgment (ACK/NACK) codebook may be determined based on candidate physical downlink shared channel (PDSCH) occasions of active CCs. Thus, one or more slots of the second CC may contain PDSCH occasions such that the UE is expected to provide HARQ feedback for those slots in addition to the slot(s) of the first CC. This approach is inefficient in that the result is the UE providing HARQ feedback for the slot(s) of the second CC that are indicated to be unscheduled.

Accordingly, aspects of the techniques described herein provide for ACK/NACK feedback that is based on an indication that one or more slots of one or more CCs will be unscheduled for a UE. In some aspects, a UE may receive configuration information that activates a set of CCs and that indicates a feedback configuration associated with the set of CCs, where the feedback configuration indicates a first feedback codebook size associated with the set of carriers. The UE also may receive control information that indicates at least a first CC of the set of CCs will be unscheduled for communications during a first set of slots. Based on the control information, the UE may monitor for one or more downlink communications (e.g., PDSCH transmissions) via a subset of the set of CCs, where the subset CCs include one or more carriers that are schedulable for communications during at least the first set of slots.

The UE may format a feedback codebook that includes ACK/NACK information associated with the one or more downlink communications, where the feedback codebook has a second codebook size that is based on the number of carriers in the subset of carriers, and that is different than the first codebook size. For example, the UE may be configured with a first CC and a second CC, and receive an indication that the second CC is not schedulable for one or more slots, and the UE may transmit a feedback codebook (e.g., a semi-static Type 1 HARQ codebook) that includes feedback information for the first carrier and for slots during which the second carrier is schedulable, and omit feedback information for the second carrier for the one or more slots that are not schedulable. In some aspects, a timeline for which slots are to be included in a feedback codebook (e.g., a downlink-data-to-uplink-acknowledgment timeline) may be updated based on the indication that one or more CCs will not be scheduled. In some aspects, the feedback time window (e.g., RRC configured K1) may be associated with each downlink carrier based on a subset of slots in which the downlink carrier is schedulable. In some aspects, two or more uplink resources may be configured for transmission of feedback, where each uplink resource is associated with a different subset of a set of configured CCs, and the UE may determine which CCs are active and which CCs are not schedulable based on which uplink resource is indicated for transmission of feedback information. In some further aspects, an indication that one or more CCs is not schedulable may be an implicit indication that indicates that X of N total active CCs will be scheduled, but not indicate which X CCs are schedulable. In such aspects, frequency segments may be defined that are associated with one or more CCs, and feedback information may be provided for the schedulable CCs in one or more indicated frequency segments. In some aspects, if two or more CCs are schedulable, the feedback information may be encoded for each slot to indicate which CC is associated with each feedback bit.

A UE operating in accordance with techniques as discussed herein may thus operate with reduced power consumption associated with narrow bandwidth communications, and also provide feedback that corresponds to carriers and slots that are schedulable at the UE. Such techniques may enhance UE operation by reducing power consumption and processing resource usage. Further, such techniques provide for reduced overhead associated with HARQ ACK/NACK feedback through codebooks that are adjusted based on carriers and slots that are schedulable at the UE.

Aspects of the disclosure are initially described in the context of wireless communications systems. Aspects of the disclosure are further illustrated by and described with reference to feedback configurations, apparatus diagrams, system diagrams, and flowcharts that relate to feedback techniques for unscheduled carriers in wireless communications.

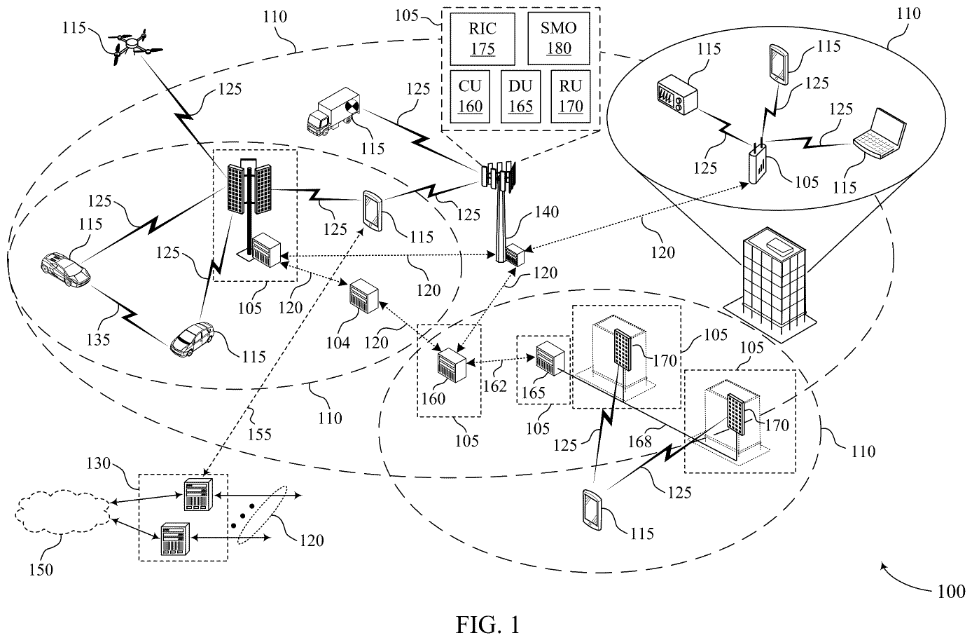

FIG. 1 shows an example of a wireless communications system 100 that supports feedback techniques for unscheduled carriers in wireless communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support feedback techniques for unscheduled carriers in wireless communications as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some aspects, a UE 115 may receive configuration information that activates a set of CCs and that indicates a feedback configuration associated with the set of CCs, where the feedback configuration indicates a first feedback codebook size associated with the set of carriers. The UE 115 also may receive control information that indicates at least a first CC of the set of CCs will be unscheduled for communications during a first set of slots. Based on the control information, the UE may monitor for one or more downlink communications (e.g., PDSCH transmissions) via a subset of the set of CCs, where the subset CCs include one or more carriers that are schedulable for communications during at least the first set of slots. In some aspects, the UE 115 may format a feedback codebook that includes ACK/NACK information associated with the one or more downlink communications, where the feedback codebook has a second codebook size that is based on the number of carriers in the subset of carriers, and that is different than the first codebook size.

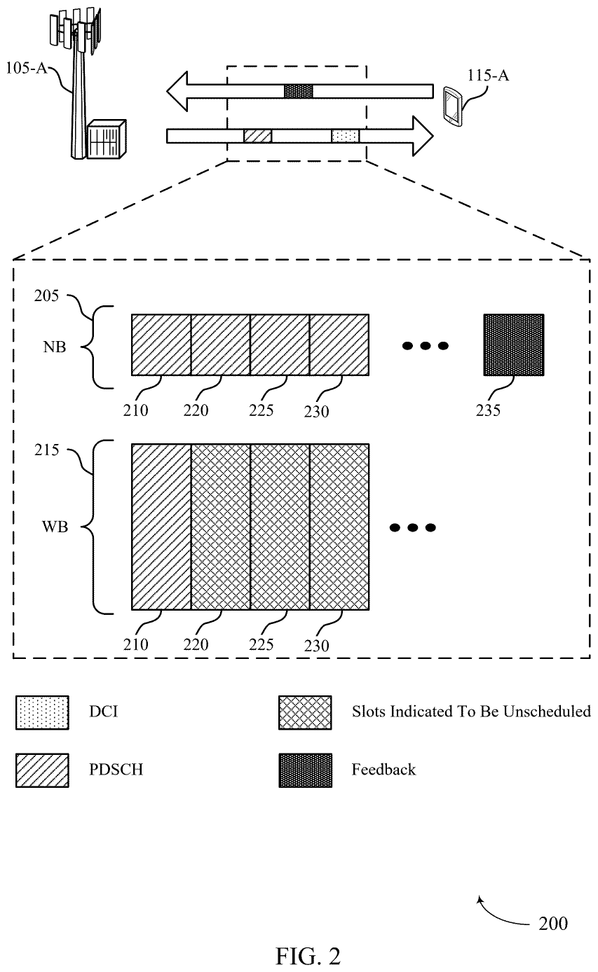

FIG. 2 shows an example of a wireless communications system 200 that supports feedback techniques for unscheduled carriers in wireless communications in accordance with one or more aspects of the present disclosure. The wireless communications system 200 may implement or may be implemented by aspects of the wireless communications system 100. For example, the wireless communications system 200 may include a UE 115-a and a network entity 105-a, which may be examples of corresponding devices described herein.

In some examples, the UE 115-a may be configured to perform RF operations, baseband operations, or both. For high throughput and wideband scheduling, the UE 115-a may enter its highest power state. In new radio (NR) wireless communications systems, the UE 115-a may move its internal baseband clock/voltage to higher power state when the UE 115-a switches to wideband scheduling. This high-power mode of the UE 115-a involves higher clock frequency and generally higher supply voltage to support the higher clock frequency, leading to a quadratic increase in power consumption as well as leakage.

In some cases, a network entity 105-a may inform the UE 115-a as to how long the UE 115-a will be scheduled with wideband scheduling such that the UE 115 may set its clock frequency and voltage as needed and not necessitate the highest setting corresponding to the wideband scheduling for longer than is needed. The UE 115-a may benefit from an indication that the UE 115-a will not be scheduled with sustained peak throughput. For example, the network entity 105-a may guarantee the UE 115-a that there will be no scheduling of PDSCH transmissions following a wideband scheduling.

In some cases, the network entity 105-a may guarantee (e.g., signal) to the UE 115-a that: a maximum scheduled throughput may not exceed a limit; feedback timeline may be relaxed; if feedback occasion is kept the same as with narrowband scheduling, the broadband may be kept at low; there will be gaps (e.g., scheduling gaps) between PDSCH transmissions, or one or more CCs (e.g., a wideband CC) will not be scheduled for a particular time period (e.g., a first time period, which may correspond to an indicated time, a number of slots, etc.).

In some examples, the UE 115-a may be configured for efficient downlink scheduling. PDSCH scheduling may be wideband but peak throughput may be reduced for the wideband scheduling by specifying that certain carriers or slots may not be scheduled and by specifying a relaxation in the feedback timeline. For example, one or more predefined communication parameters or rules may indicate that the UE 115-a will not be scheduled with any PDSCH transmission in one or more carriers. In an efficient scheduling mode, the UE 115-a may perform decoupling of RF and baseband power state, which may enable reduction in UE energy. For example, the network entity 105-a may configure the UE 115-a with multiple CCs, including a narrowband CC 205 (e.g., a carrier that occupies a 20 MHz channel bandwidth) and a wideband CC 215 (e.g., a carrier that occupies a 100 MHz channel bandwidth). In this example, both the narrowband CC 205 and the wideband CC 215 may be scheduled in a first slot 210, and only the narrowband CC 205 may be scheduled in a second slot 220, third slot 225, and fourth slot 230. In some cases, the UE 115-a may receive information subsequent to being configured with the multiple CCs that indicates that one or more slots are to be unscheduled for the wideband CC 215 (e.g., in RRC signaling, in a MAC control element (MAC-CE), or in downlink control information (DCI)). Based on this indication, the UE 115-a may skip monitoring the slots indicated to be unscheduled.

Further, in various aspects, the UE 115-a may transmit ACK/NACK feedback 235, which may include feedback information that is based on one or more carriers that are indicated to be unscheduled. In some aspects, the UE 115-a may receive configuration information that activates a set of CCs and that indicates a feedback configuration associated with the set of CCs, where the feedback configuration indicates a first feedback codebook size associated with the set of carriers. The UE 115-a also may receive control information that indicates at least a first CC (e.g., the wideband CC 215) of the set of CCs will be unscheduled for communications during a first set of slots (e.g., second slot 220, third slot 225, and fourth slot 230). Based on the control information, the UE 115-a may monitor for one or more downlink communications (e.g., PDSCH transmissions) via the schedulable CCs (e.g., the narrowband CC 205 and the schedulable first slot 210 of the wideband CC 215). Thus, such scheduling techniques provide that an active cell may be in an active-schedulable state and an active-standby state (or unschedulable state). The standby state is different than simply not scheduling a carrier (in which case the UE 115-a would monitor for communications on the carrier), because it is based on a reliable indication that a carrier will not be scheduled for some time period, thereby allowing the UE 115-a to reduce power consumption.

In some aspects, the UE 115-a may format a feedback codebook that includes ACK/NACK information associated with the one or more downlink communications, where the feedback codebook has a second codebook size that is based on the schedulable carriers and slots, and that is different than the first codebook size. In some aspects, a timeline for which slots are to be included in a feedback codebook (e.g., a downlink-data-to-uplink-acknowledgment timeline) may be updated based on the indication that one or more CCs will not be scheduled. In some aspects, the feedback time window (e.g., RRC configured K1) may be associated with each downlink carrier based on a subset of slots in which the downlink carrier is schedulable.

In some aspects, two or more uplink resources may be configured for transmission of feedback, where each uplink resource is associated with a different subset of a set of configured CCs, and the UE 115-a may determine which CCs are active and which CCs are not schedulable based on which uplink resource is indicated for transmission of feedback 235 information. In some further aspects, an indication that one or more CCs is not schedulable may be an implicit indication that indicates that X of N total active CCs will be scheduled, but not indicate which X CCs are schedulable. In such aspects, frequency segments may be defined that are associated with one or more CCs, and feedback 235 information may be provided for the schedulable CCs in one or more indicated frequency segments. In some aspects, if two or more CCs are schedulable, the feedback 235 information may be encoded for each slot to indicate which CC is associated with each feedback bit.

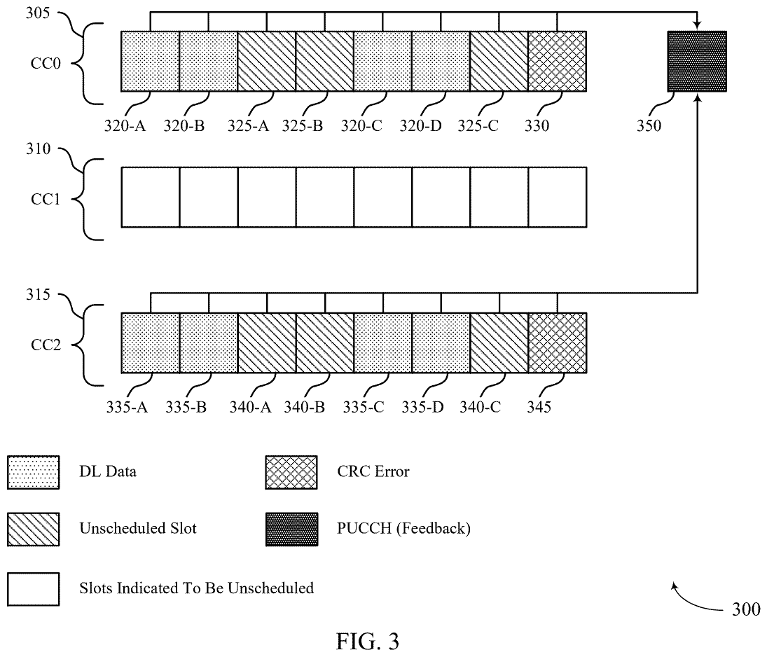

FIG. 3 shows an example of a feedback configuration 300 that supports feedback techniques for unscheduled carriers in wireless communications in accordance with one or more aspects of the present disclosure. Feedback configuration 300 may implement or be implemented in aspects of wireless communications system 100 or wireless communications system 200. Aspects of feedback configuration 300 may be implemented at or implemented by a UE or a network entity, which may be examples of the corresponding devices described herein.

In some cases, the network may indicate to or otherwise inform the UE regarding which CCs of two or more configured CCs will be scheduled for communications so that the UE can set its clock frequency and voltage as needed and necessary. That is, the UE may need to know that it will not be scheduled with sustained peak throughput and may not need to ramp up the clock to the highest power state. As one non-limiting example, the UE may be configured with a first CC 305 (CC0), a second CC 310 (CC1), and a third CC 315 (CC2), and may be indicated that scheduling is only for the first CC 305 and the third CC 315 for a period of time. In this example, the UE may relax its processing timeline and the baseband operations of the UE may be maintained at a lower power state based on fewer CCs being active for the time period.

The UE may also be configured to provide HARQ feedback for the communications scheduled in the schedulable CCs (e.g., for downlink data transmissions to the UE). One example of such feedback may include a Type 1 HARQ codebook, which may also be referred to as a semi-static feedback codebook. In this example, the codebook may be determined via semi-static information based on candidate PDSCH reception occasions. Semi-static information may refer to information that is received by the UE less frequently (e.g., information received via RRC signaling) than some other information received more frequently that may instead be referred to as dynamic information (e.g., information received via DCI signaling). The UE may not consider physical downlink control channel (PDCCH) monitoring occasions for the Type 1 HARQ-ACK codebook for the unschedulable CC (e.g., the second CC 310). Thus, the set of PDSCH monitoring occasions may be determined on a per-downlink serving cell (e.g., CC) basis, and the semi-static feedback or Type 1 HARQ codebook may be based on the set of candidate PDSCH reception occasions of the first CC 305 and the third CC 315. In this example, downlink data may be transmitted in slots 320-a, 320-b, 320-c, 320-d, and 330 of the first CC 305, and in slots 335-a, 335-b, 335-c, 335-d, and 345 of the third CC 315. Further, one or more slots may be schedulable but may not include any scheduled downlink data (e.g., which may be indicated in a scheduling DCI), such as slots 325-a, 325-b, and 325-c of the first CC 305, and slots 340-a, 340-b, and 340-c of the third CC 315. Additionally, in this example, a CRC error may be identified in slot 330 of the first CC 305 and in slot 345 of the third CC 315. Thus, in this example, physical uplink control channel (PUCCH) feedback 350 may include a feedback codebook that includes bits that indicate ACK or NACK (e.g., for slots 330 and 345) for each of the first CC 305 and the third CC 315 that are schedulable at the UE.

In some wireless communications systems, the UE may include bits in the semi-static feedback (e.g., the semi-static codebook) for every candidate PDSCH occasion during a time window. Accordingly, in such wireless communications systems, the semi-static feedback or Type 1 HARQ codebook may have a fixed size that depends upon the number of candidate PDSCH monitoring occasions within the time window. In this example, the HARQ codebook may be modified based on an indication that the second CC 310 is unschedulable, to not include bits associated with candidate PDSCH monitoring occasions of the second CC 310. Accordingly, overhead associated with feedback can be reduced, further reducing power consumption at the UE and also enhancing efficient use of wireless resources.

The PDSCH monitoring occasions that are included in a codebook may be based on a set of K1 values may be configured for the UE, which may include a set of possible slot timing offset values (e.g., the offset between the PDSCH and the corresponding HARQ-ACK feedback) that may be indicated in the DCI that schedules the PDSCH transmissions to the UE. Possible K1 values may include {1,2,3,4,5,6,7,8} if only DCI format 1_0 is configured and DCI format 1_1 is not configured for the serving cell. If the DCI format 1_1 or 1_2 are configured for the serving cell, then the K1 value is provided by a dl-DataToUL-ACK parameter. For each K1 value, the set of PDSCH time domain resource allocation (TDRA) candidates (e.g., corresponding to a start and length indicator value (SLIV) within a slot) may be considered. In some aspects, the TDRA candidates that overlap with semi-static uplink symbols may be removed (e.g., for TDD). In some aspects, the remaining TDRA row may be grouped such that the number of groups is the maximum number of non-overlapping SLIVs in the slot. This may be unnecessary if the maximum number of PDSCH messages (or “PDSCHs”) per slot is one (e.g., based on UE capability or RRC configuration).

The Type 1 HARQ-ACK codebook may accommodate as many bits as potential PDSCH reception occasions (only a subset of PDSCH transmissions may be actually scheduled). For example, if the TDRA indicates SLIVs for symbols {0-6}, {7-13}, there are two bits per K1 value per CC. If K1 equals (1,2,3), there are 2*3 bits per CC for FDD (and slightly less for TDD depending on how many SLIVs overlap with uplink symbols). Accordingly, the UE may determine the PDSCH reception or monitoring occasions based on the K1 set and the SLIV and then determine the HARQ-ACK codebook based on the candidate PDSCH reception or monitoring occasions.

In the example of FIG. 3, if the standby indication associated with the second CC 310 is semi-static or semi-persistent, and indicated via RRC or a MAC-CE, then the valid downlink slots in the dl-DataToUL-ACK associated with the PUCCH slot corresponds to a feedback location for all active CCs (e.g., the first CC 305 and the third CC 315), except the standby or unschedulable second CC 310 will not have any ACK/NACK bits in the feedback codebook.

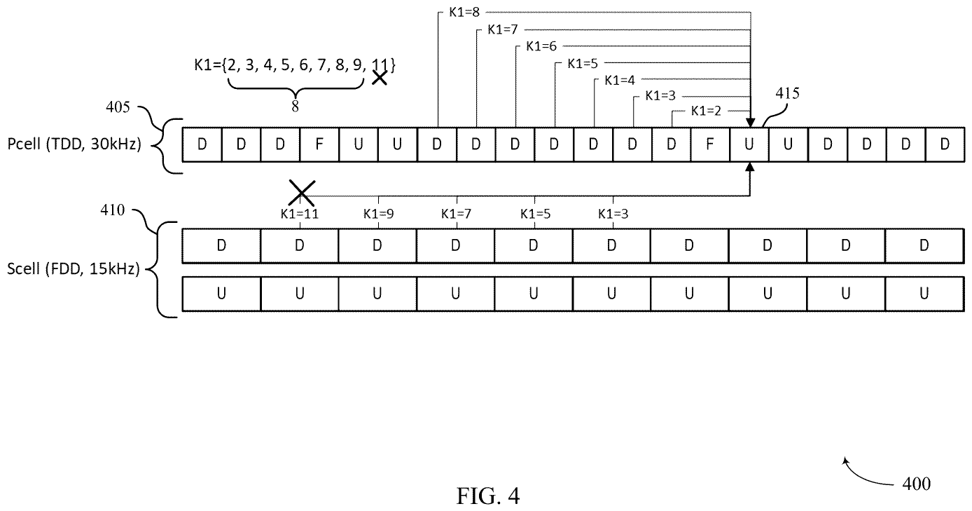

FIG. 4 shows an example of a feedback configuration 400 that supports feedback techniques for unscheduled carriers in wireless communications in accordance with one or more aspects of the present disclosure. Feedback configuration 400 may implement or be implemented in aspects of wireless communications system 100 or wireless communications system 200. Aspects of feedback configuration 400 may be implemented at or implemented by a UE or a network entity, which may be examples of the corresponding devices described herein.

As discussed herein, in some aspects, the network may indicate to or otherwise inform the UE regarding which CCs of two or more configured CCs will be scheduled for communications so that the UE can set its clock frequency and voltage as needed and necessary. In this example a primary cell (PCell) 405 may be associated with a first CC that may be a TDD carrier, and a secondary cell (Scell) 410 may be configured for FDD communications via an uplink carrier and a downlink carrier. In this example, as part of the indication that indicates certain CCs are in standby, the network may provide an updated dl-DataToUL-ACK (for a group of CCs) that indicates that only subset of K1 values are now valid. In some cases, based on when the indication that a CC will not be scheduled is received, a new K1 set may be reduced to K1′. In the example of FIG. 4, the updated feedback timeline (e.g., K1 values) may apply to DataToUL-ACK per downlink CC, which in this example if the SCell 410 is in standby, than K1=11 is removed, and feedback provided in uplink slot 415 may be based on K1 values of {2, 3, 4, 5, 6, 7, 8, 9}.

In some other aspects, for a given PUCCH slot and feedback time window associated with the PUCCH, across different times the different CCs may be accounted differently in the feedback codebook, depending on whether an associated CC is active and schedulable versus active and non-schedulable (standby) in accordance with signaling that indicates that one or more CCs will not be scheduled. In some aspects, both the network and the UE may be aware of the non-schedulable indication(s) provided to the UE, and may adjust associated feedback codebooks accordingly.

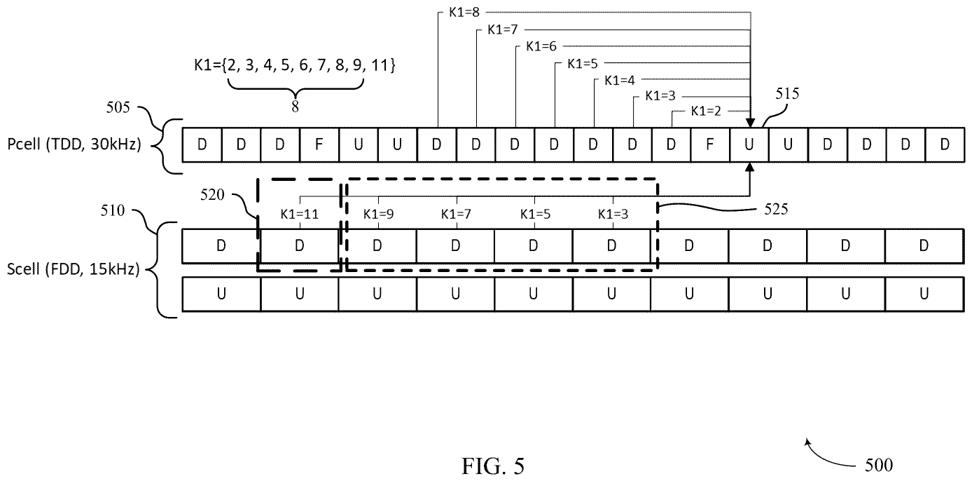

FIG. 5 shows an example of a feedback configuration 500 that supports feedback techniques for unscheduled carriers in wireless communications in accordance with one or more aspects of the present disclosure. Feedback configuration 500 may implement or be implemented in aspects of wireless communications system 100 or wireless communications system 200. Aspects of feedback configuration 500 may be implemented at or implemented by a UE or a network entity, which may be examples of the corresponding devices described herein.

As discussed herein, in some aspects, the network may indicate to or otherwise inform the UE regarding which CCs of two or more configured CCs will be scheduled for communications so that the UE can set its clock frequency and voltage in accordance with a bandwidth used for communications. In this example a PCell 505 may be associated with a first CC that may be a TDD carrier, and a Scell 510 may be configured for FDD communications via an uplink carrier and a downlink carrier. In this example, as part of the indication that indicates certain CCs are in standby, the network may provide a feedback time window (e.g., RRC configured K1) associated with each DL CC is based on a subset of slots in which the downlink CC is schedulable. In this example, a subset of slots 520 may be unschedulable, and another subset of slots 525 may be located in the time window associated with the PUCCH resource 515 for transmission of ACK/NACK feedback.

In some further aspects, the PUCCH resource 515 may be associated with a first subset of CCs, and a different PUCCH resource may be associated with a different subset of CCs. In such aspects, an indication of the PUCCH resource 515 may indicate that the first subset of CCs are the only schedulable CCs. For example, PUCCH resource 1 may be associated with CC1 and CC3 and PUCCH resource 2 may be associated with CC2 and CC3. From an indication of PUCCH resource 1 or PUCCH resource 2, the UE may determine which of the active CCs is in standby (e.g., guaranteed not to be scheduled) and which are not (e.g., are schedulable).

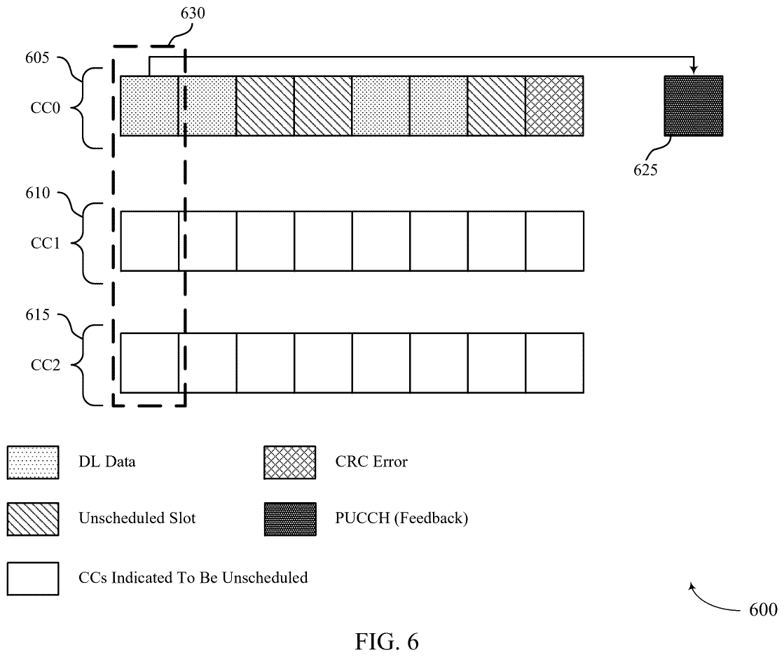

FIG. 6 shows an example of a feedback configuration 600 that supports feedback techniques for unscheduled carriers in wireless communications in accordance with one or more aspects of the present disclosure. Feedback configuration 600 may implement or be implemented in aspects of wireless communications system 100 or wireless communications system 200. Aspects of feedback configuration 600 may be implemented at or implemented by a UE or a network entity, which may be examples of the corresponding devices described herein.

In some aspects, as discussed herein, the network may indicate to or otherwise inform the UE regarding which CCs of two or more configured CCs will be scheduled for communications so that the UE can set its clock frequency and voltage as needed and necessary. As one non-limiting example, the UE may be configured with a first CC 605 (CC0), a second CC 610 (CC1), and a third CC 615 (CC2). Further, an indication that one or more CCs is not schedulable may be an implicit indication that indicates that X of N total active CCs will be scheduled, but not indicate which X CCs are schedulable. For example, with reference to FIG. 6, the UE may receive an indication that one CC is schedulable, but not an indication of whether that one CC is the first CC 605, the second CC 610, or the third CC 615. In another example, the UE may receive an indication that two CCs are schedulable, but not an indication of which two.

In some aspects, frequency segments may be defined that are associated with one or more CCs, and feedback information 625 may be provided for the schedulable CCs in one or more indicated frequency segments for a slot 630 or other time segment. In some aspects, if two or more CCs are schedulable, the feedback information may be encoded for each slot to indicate which CC is associated with each feedback bit. For example, if there are multiple PDSCHs scheduled within one time segment, the corresponding ACK/NACK bits may be bundled into one ACK/NACK bit (e.g., bundled by application of a logical AND operation to the ACK/NACK bits of the HARQ-ACK codebook).

In some aspects, the HARQ feedback may be encoded to indicate which of the scheduled CCs the feedback applies to. In some cases, a UE may receive a plurality of simultaneous downlink transmissions during a time period of two or more CCs, where the plurality of simultaneous downlink transmissions received by the UE are less than k (e.g., (k−1) downlink transmissions or (k−2) downlink transmissions). Each of the plurality of simultaneous downlink transmissions may be characterized by a binary vector indicating a corresponding downlink transmission occasion having a weight of (k−1) or (k−2). Because the number of downlink transmissions that are successfully received during a given time period are less than k, there may be at least one downlink transmission that failed.

Thus, in some examples, the UE may generate an encoded HARQ feedback by calculating a parity value of a first downlink transmission of the plurality of simultaneous downlink transmissions based at least on the binary vector corresponding to the first downlink transmission. The UE may then calculate a summing value based at least on a summation of the parity value with a codeword index of each of the plurality of simultaneous downlink transmissions other than the first downlink transmission. The UE may then transmit the summing value to the base station as a HARQ feedback, which may indicate which of the CCs are associated with different HARQ feedback.

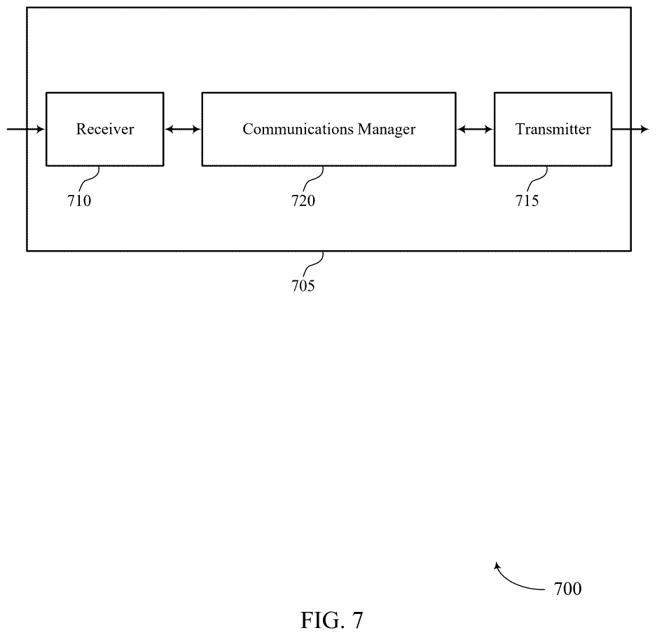

FIG. 7 shows a block diagram 700 of a device 705 that supports feedback techniques for unscheduled carriers in wireless communications in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to feedback techniques for unscheduled carriers in wireless communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to feedback techniques for unscheduled carriers in wireless communications). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of feedback techniques for unscheduled carriers in wireless communications as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving first control information that activates a set of carriers at the UE, and that indicates a feedback configuration associated with the set of carriers, where the set of carriers includes two or more carriers and the feedback configuration indicates a first feedback codebook size associated with a first quantity of carriers of the set of carriers. The communications manager 720 is capable of, configured to, or operable to support a means for receiving second control information that indicates at least a first carrier of the set of carriers will be unscheduled for communications during at least a first time period. The communications manager 720 is capable of, configured to, or operable to support a means for monitoring for one or more downlink communications via a subset of the set of carriers that are schedulable for communications during at least the first time period in accordance with the second control information, where the subset of carriers includes a second quantity of carriers. The communications manager 720 is capable of, configured to, or operable to support a means for transmitting a first feedback codebook that includes first feedback information associated with the one or more downlink communications, where the first feedback codebook has a second codebook size that is based on the second quantity of carriers and that is different than the first codebook size.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for HARQ ACK/NACK feedback through codebooks that are adjusted based on carriers and slots that are schedulable at the UE, which may enhance UE operation by reducing power consumption and processing resource usage, and also provide for more efficient usage of communications resources associated with reduced overhead for feedback transmissions.

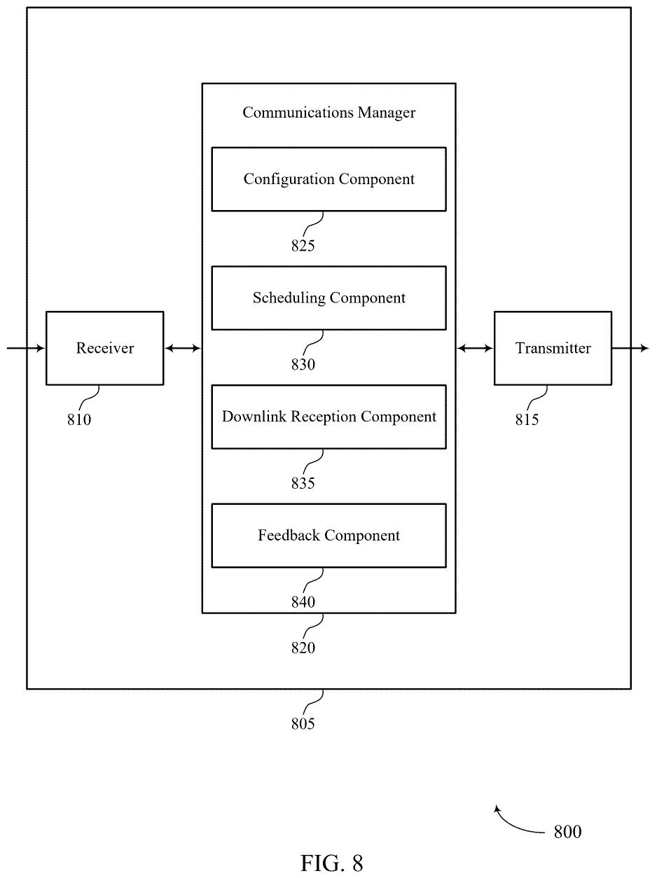

FIG. 8 shows a block diagram 800 of a device 805 that supports feedback techniques for unscheduled carriers in wireless communications in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to feedback techniques for unscheduled carriers in wireless communications). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to feedback techniques for unscheduled carriers in wireless communications). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of feedback techniques for unscheduled carriers in wireless communications as described herein. For example, the communications manager 820 may include a configuration component 825, a scheduling component 830, a downlink reception component 835, a feedback component 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The configuration component 825 is capable of, configured to, or operable to support a means for receiving first control information that activates a set of carriers at the UE, and that indicates a feedback configuration associated with the set of carriers, where the set of carriers includes two or more carriers and the feedback configuration indicates a first feedback codebook size associated with a first quantity of carriers of the set of carriers. The scheduling component 830 is capable of, configured to, or operable to support a means for receiving second control information that indicates at least a first carrier of the set of carriers will be unscheduled for communications during at least a first time period. The downlink reception component 835 is capable of, configured to, or operable to support a means for monitoring for one or more downlink communications via a subset of the set of carriers that are schedulable for communications during at least the first time period in accordance with the second control information, where the subset of carriers includes a second quantity of carriers. The feedback component 840 is capable of, configured to, or operable to support a means for transmitting a first feedback codebook that includes first feedback information associated with the one or more downlink communications, where the first feedback codebook has a second codebook size that is based on the second quantity of carriers and that is different than the first codebook size.

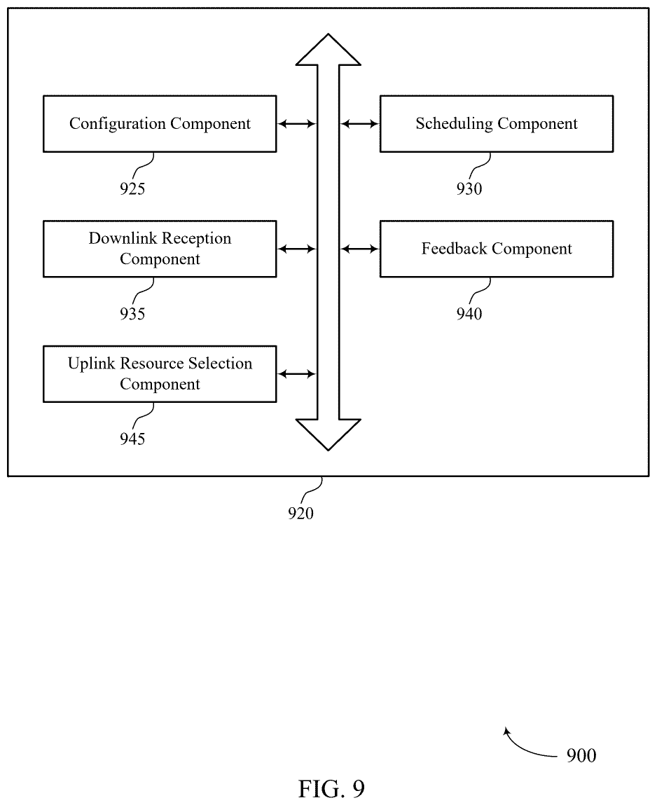

FIG. 9 shows a block diagram 900 of a communications manager 920 that supports feedback techniques for unscheduled carriers in wireless communications in accordance with one or more aspects of the present disclosure. The communications manager 920 may be an example of aspects of a communications manager 720, a communications manager 820, or both, as described herein. The communications manager 920, or various components thereof, may be an example of means for performing various aspects of feedback techniques for unscheduled carriers in wireless communications as described herein. For example, the communications manager 920 may include a configuration component 925, a scheduling component 930, a downlink reception component 935, a feedback component 940, an uplink resource selection component 945, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The configuration component 925 is capable of, configured to, or operable to support a means for receiving first control information that activates a set of carriers at the UE, and that indicates a feedback configuration associated with the set of carriers, where the set of carriers includes two or more carriers and the feedback configuration indicates a first feedback codebook size associated with a first quantity of carriers of the set of carriers. The scheduling component 930 is capable of, configured to, or operable to support a means for receiving second control information that indicates at least a first carrier of the set of carriers will be unscheduled for communications during at least a first time period. The downlink reception component 935 is capable of, configured to, or operable to support a means for monitoring for one or more downlink communications via a subset of the set of carriers that are schedulable for communications during at least the first time period in accordance with the second control information, where the subset of carriers includes a second quantity of carriers. The feedback component 940 is capable of, configured to, or operable to support a means for transmitting a first feedback codebook that includes first feedback information associated with the one or more downlink communications, where the first feedback codebook has a second codebook size that is based on the second quantity of carriers and that is different than the first codebook size.

In some examples, to support receiving the second control information, the scheduling component 930 is capable of, configured to, or operable to support a means for receiving RRC signaling or a medium access control (MAC) control element that indicates that at least the first carrier of the set of carriers will be unscheduled for communications until a subsequent control information transmission provides an indication that at least the first carrier is schedulable.

In some examples, the second codebook size is based on the second quantity of carriers and a quantity of slots within a feedback time duration indicated in the feedback configuration. In some examples, the feedback configuration indicates a feedback codebook that has a fixed quantity of bits. In some examples, the first control information further indicates a first feedback timing information associated with a quantity of slots between a downlink data slot and an uplink slot that includes feedback information, and the second control information further indicates an update to the first feedback timing information. In some examples, the first feedback timing information includes a set of downlink-data-to-uplink-acknowledgment values, and the second control information indicates that one or more of the downlink-data-to-uplink-acknowledgment values are not used for determining the first feedback information.

In some examples, the first feedback codebook is transmitted in a first uplink slot and the feedback information is associated with the one or more downlink communications within a feedback window prior to the first uplink slot, and where the second control information further indicates an update to the feedback window. In some examples, the first feedback information is associated with the subset of carriers, and one or more subsequent feedback codebooks include subsequent feedback information associated with a different quantity of carriers than the second quantity of carriers in accordance with subsequent control information that indicates at least the first carrier of the set of carriers is schedulable for communications during a subsequent time period, or that at least a second carrier of the set of carriers will be unscheduled during the subsequent time period.

In some examples, the feedback configuration includes a feedback time window associated with each carrier of the set of carriers, and a feedback time window associated with each carrier of the subset of carriers is based on a set of slots in which a corresponding carrier can be scheduled for downlink communications. In some examples, the first control information further indicates a first uplink resource for transmission of feedback information that is associated with the set of carriers, and a second uplink resource for transmission of feedback information that is associated with the subset of carriers. In some examples, the second control information includes an indication of which of the first uplink resource or the second uplink resource is to be used for transmission of the first feedback information.

In some examples, the first control information further indicates a set of multiple frequency segments that are each associated with one or more carriers of the set of carriers, and the second control information indicates a quantity of the set of multiple frequency segments that will be unscheduled for communications during at least the first time period. In some examples, the feedback component 940 is capable of, configured to, or operable to support a means for bundling feedback information for one or more carriers that are included in a remaining quantity of the set of multiple frequency segments.

In some examples, to support bundling the feedback information, the feedback component 940 is capable of, configured to, or operable to support a means for including feedback information associated with each slot of a set of downlink slots associated with a single carrier when the single carrier is included in a remaining quantity of the set of multiple frequency segments. In some examples, to support bundling the feedback information, the feedback component 940 is capable of, configured to, or operable to support a means for encoding feedback information from two or more carriers for each slot of the set of downlink slots when two or more carriers are included in the remaining quantity of the set of multiple frequency segments, where the encoded feedback information indicates feedback information for each of the two or more carriers that are schedulable in the remaining quantity of the set of multiple frequency segments.

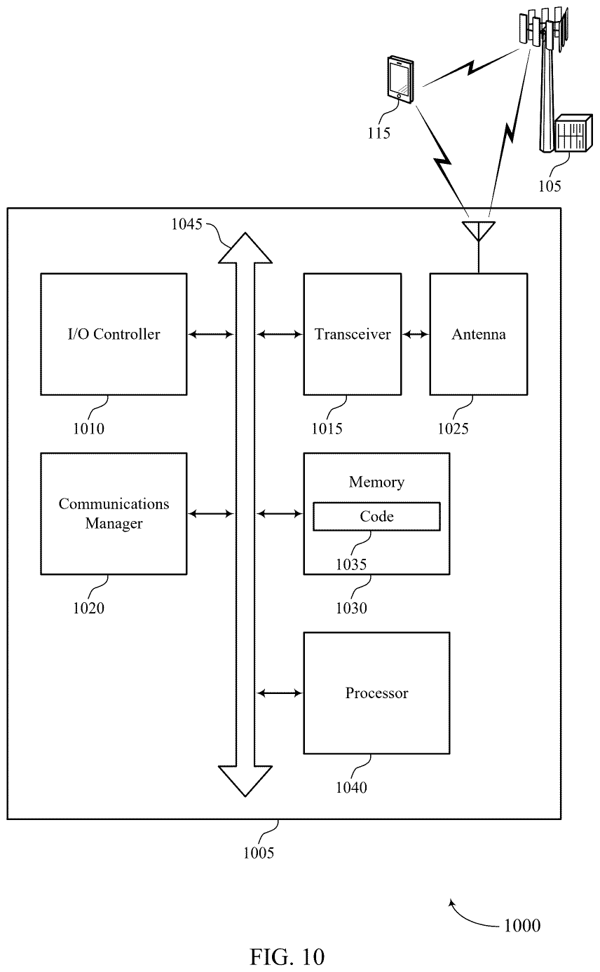

FIG. 10 shows a diagram of a system 1000 including a device 1005 that supports feedback techniques for unscheduled carriers in wireless communications in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting feedback techniques for unscheduled carriers in wireless communications). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving first control information that activates a set of carriers at the UE, and that indicates a feedback configuration associated with the set of carriers, where the set of carriers includes two or more carriers and the feedback configuration indicates a first feedback codebook size associated with a first quantity of carriers of the set of carriers. The communications manager 1020 is capable of, configured to, or operable to support a means for receiving second control information that indicates at least a first carrier of the set of carriers will be unscheduled for communications during at least a first time period. The communications manager 1020 is capable of, configured to, or operable to support a means for monitoring for one or more downlink communications via a subset of the set of carriers that are schedulable for communications during at least the first time period in accordance with the second control information, where the subset of carriers includes a second quantity of carriers. The communications manager 1020 is capable of, configured to, or operable to support a means for transmitting a first feedback codebook that includes first feedback information associated with the one or more downlink communications, where the first feedback codebook has a second codebook size that is based on the second quantity of carriers and that is different than the first codebook size.

By including or configuring the communications manager 1020 in accordance with examples as described herein, the device 1005 may support techniques for HARQ ACK/NACK feedback through codebooks that are adjusted based on carriers and slots that are schedulable at the UE, which may enhance UE operation by reducing power consumption and processing resource usage, and also provide for more efficient usage of communications resources associated with reduced overhead for feedback transmissions.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of feedback techniques for unscheduled carriers in wireless communications as described herein, or the at least one processor 1040 and the at least one memory 1030 may be otherwise configured to, individually or collectively, perform or support such operations.

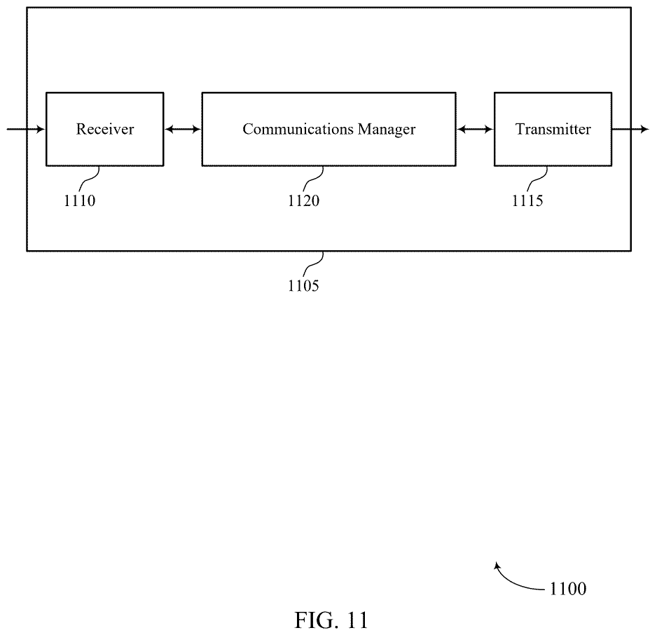

FIG. 11 shows a block diagram 1100 of a device 1105 that supports feedback techniques for unscheduled carriers in wireless communications in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of feedback techniques for unscheduled carriers in wireless communications as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for outputting first control information that activates a set of carriers at a UE, and that indicates a feedback configuration associated with the set of carriers, where the set of carriers includes two or more carriers and the feedback configuration indicates a first feedback codebook size associated with a first quantity of carriers of the set of carriers. The communications manager 1120 is capable of, configured to, or operable to support a means for outputting second control information that indicates at least a first carrier of the set of carriers will be unscheduled for communications during at least a first time period. The communications manager 1120 is capable of, configured to, or operable to support a means for outputting for one or more downlink communications via a subset of the set of carriers that are schedulable for communications during at least the first time period in accordance with the second control information, where the subset of carriers includes a second quantity of carriers. The communications manager 1120 is capable of, configured to, or operable to support a means for obtaining a first feedback codebook that includes first feedback information associated with the one or more downlink communications, where the first feedback codebook has a second codebook size that is based on the second quantity of carriers and that is different than the first codebook size.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for HARQ ACK/NACK feedback through codebooks that are adjusted based on carriers and slots that are schedulable at the UE, which may enhance UE operation by reducing power consumption and processing resource usage, and also provide for more efficient usage of communications resources associated with reduced overhead for feedback transmissions.

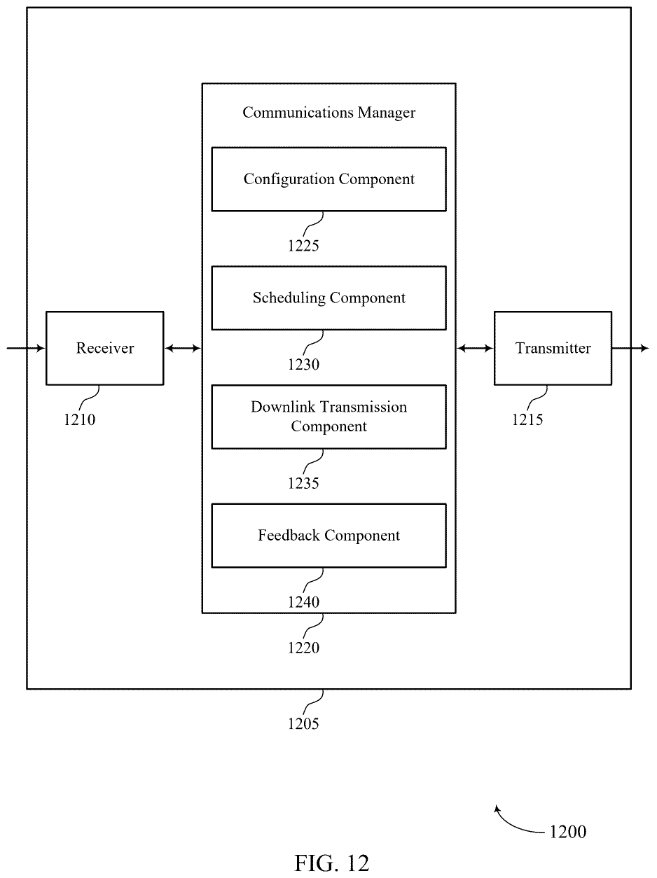

FIG. 12 shows a block diagram 1200 of a device 1205 that supports feedback techniques for unscheduled carriers in wireless communications in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of feedback techniques for unscheduled carriers in wireless communications as described herein. For example, the communications manager 1220 may include a configuration component 1225, a scheduling component 1230, a downlink transmission component 1235, a feedback component 1240, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The configuration component 1225 is capable of, configured to, or operable to support a means for outputting first control information that activates a set of carriers at a UE, and that indicates a feedback configuration associated with the set of carriers, where the set of carriers includes two or more carriers and the feedback configuration indicates a first feedback codebook size associated with a first quantity of carriers of the set of carriers. The scheduling component 1230 is capable of, configured to, or operable to support a means for outputting second control information that indicates at least a first carrier of the set of carriers will be unscheduled for communications during at least a first time period. The downlink transmission component 1235 is capable of, configured to, or operable to support a means for outputting for one or more downlink communications via a subset of the set of carriers that are schedulable for communications during at least the first time period in accordance with the second control information, where the subset of carriers includes a second quantity of carriers. The feedback component 1240 is capable of, configured to, or operable to support a means for obtaining a first feedback codebook that includes first feedback information associated with the one or more downlink communications, where the first feedback codebook has a second codebook size that is based on the second quantity of carriers and that is different than the first codebook size.

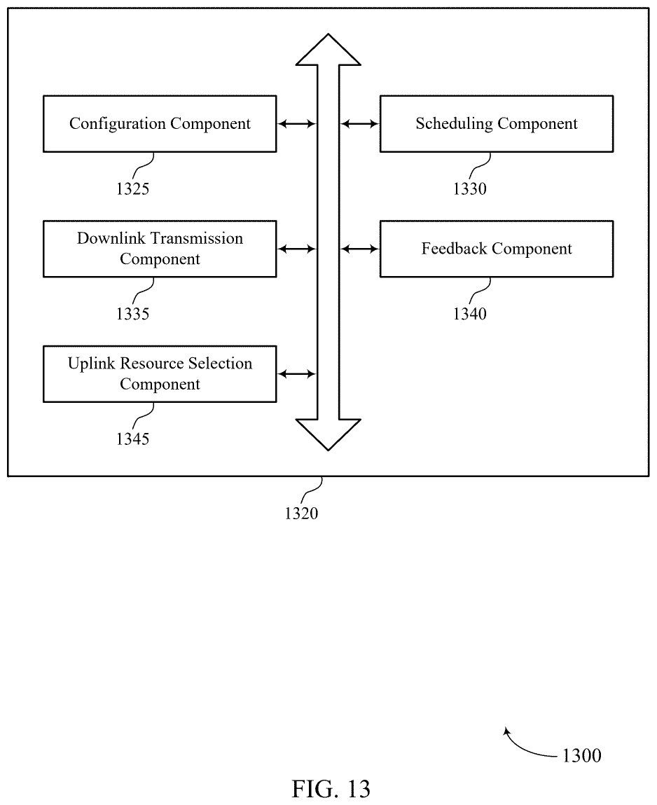

FIG. 13 shows a block diagram 1300 of a communications manager 1320 that supports feedback techniques for unscheduled carriers in wireless communications in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of feedback techniques for unscheduled carriers in wireless communications as described herein. For example, the communications manager 1320 may include a configuration component 1325, a scheduling component 1330, a downlink transmission component 1335, a feedback component 1340, an uplink resource selection component 1345, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The configuration component 1325 is capable of, configured to, or operable to support a means for outputting first control information that activates a set of carriers at a UE, and that indicates a feedback configuration associated with the set of carriers, where the set of carriers includes two or more carriers and the feedback configuration indicates a first feedback codebook size associated with a first quantity of carriers of the set of carriers. The scheduling component 1330 is capable of, configured to, or operable to support a means for outputting second control information that indicates at least a first carrier of the set of carriers will be unscheduled for communications during at least a first time period. The downlink transmission component 1335 is capable of, configured to, or operable to support a means for outputting for one or more downlink communications via a subset of the set of carriers that are schedulable for communications during at least the first time period in accordance with the second control information, where the subset of carriers includes a second quantity of carriers. The feedback component 1340 is capable of, configured to, or operable to support a means for obtaining a first feedback codebook that includes first feedback information associated with the one or more downlink communications, where the first feedback codebook has a second codebook size that is based on the second quantity of carriers and that is different than the first codebook size.

In some examples, to support outputting the second control information, the scheduling component 1330 is capable of, configured to, or operable to support a means for outputting RRC signaling or a medium access control (MAC) control element that indicates that at least the first carrier of the set of carriers will be unscheduled for communications until a subsequent control information transmission provides an indication that at least the first carrier is schedulable.

In some examples, the second codebook size is based on the second quantity of carriers and a quantity of slots within a feedback time duration indicated in the feedback configuration. In some examples, the feedback configuration indicates a feedback codebook that has a fixed quantity of bits. In some examples, the first control information further indicates a first feedback timing information associated with a quantity of slots between a downlink data slot and an uplink slot that includes feedback information, and the second control information further indicates an update to the first feedback timing information. In some examples, the first feedback timing information includes a set of downlink-data-to-uplink-acknowledgment values, and the second control information indicates that one or more of the downlink-data-to-uplink-acknowledgment values are not used for determining the first feedback information. In some examples, the first feedback codebook is provided in a first uplink slot and the feedback information is associated with the one or more downlink communications within a feedback window prior to the first uplink slot, and where the second control information further indicates an update to the feedback window.

In some examples, the first feedback information is associated with the subset of carriers, and one or more subsequent feedback codebooks include subsequent feedback information associated with a different quantity of carriers than the second quantity of carriers in accordance with subsequent control information that indicates at least the first carrier of the set of carriers is schedulable for communications during a subsequent time period, or that at least a second carrier of the set of carriers will be unscheduled during the subsequent time period. In some examples, the feedback configuration includes a feedback time window associated with each carrier of the set of carriers, and a feedback time window associated with each carrier of the subset of carriers is based on a set of slots in which a corresponding carrier can be scheduled for downlink communications.

In some examples, the first control information further indicates a first uplink resource for transmission of feedback information that is associated with the set of carriers, and a second uplink resource for transmission of feedback information that is associated with the subset of carriers. In some examples, the second control information includes an indication of which of the first uplink resource or the second uplink resource is to be used for transmission of the first feedback information.

In some examples, the first control information further indicates a set of multiple frequency segments that are each associated with one or more carriers of the set of carriers, and the second control information indicates a quantity of the set of multiple frequency segments that will be unscheduled for communications during at least the first time period. In some examples, the first feedback information includes bundled feedback for one or more carriers that are included in a remaining quantity of the set of multiple frequency segments. In some examples, the bundled feedback includes a feedback indication associated with each slot of a set of downlink slots associated with a single carrier when the single carrier is included in a remaining quantity of the set of multiple frequency segments. In some examples, the bundled feedback includes encoded feedback information from two or more carriers for each slot of the set of downlink slots when two or more carriers are included in the remaining quantity of the set of multiple frequency segments, where the encoded feedback information indicates feedback information for each of the two or more carriers that are schedulable in the remaining quantity of the set of multiple frequency segments.

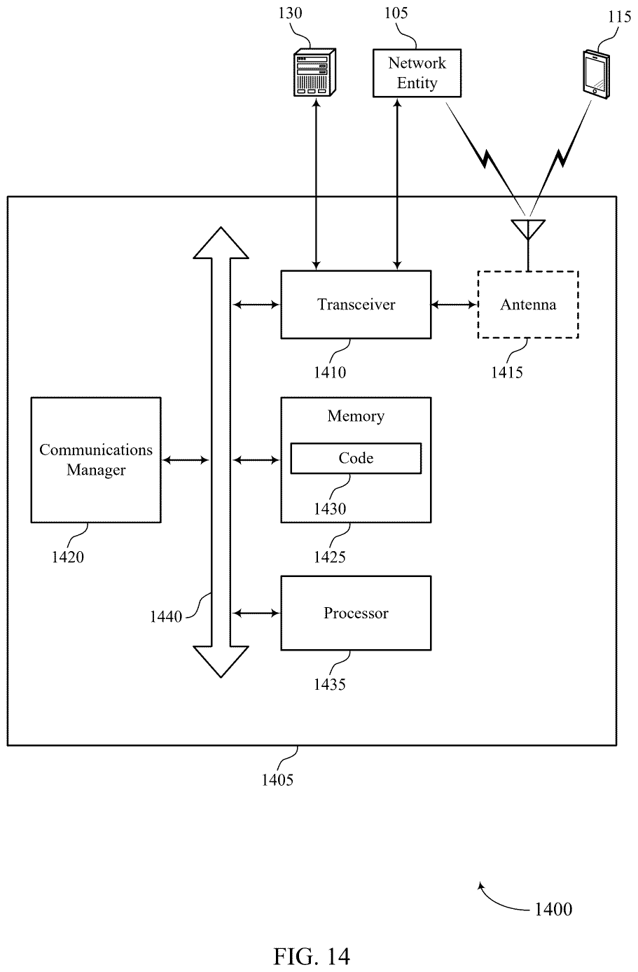

FIG. 14 shows a diagram of a system 1400 including a device 1405 that supports feedback techniques for unscheduled carriers in wireless communications in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting feedback techniques for unscheduled carriers in wireless communications). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for outputting first control information that activates a set of carriers at a UE, and that indicates a feedback configuration associated with the set of carriers, where the set of carriers includes two or more carriers and the feedback configuration indicates a first feedback codebook size associated with a first quantity of carriers of the set of carriers. The communications manager 1420 is capable of, configured to, or operable to support a means for outputting second control information that indicates at least a first carrier of the set of carriers will be unscheduled for communications during at least a first time period. The communications manager 1420 is capable of, configured to, or operable to support a means for outputting for one or more downlink communications via a subset of the set of carriers that are schedulable for communications during at least the first time period in accordance with the second control information, where the subset of carriers includes a second quantity of carriers. The communications manager 1420 is capable of, configured to, or operable to support a means for obtaining a first feedback codebook that includes first feedback information associated with the one or more downlink communications, where the first feedback codebook has a second codebook size that is based on the second quantity of carriers and that is different than the first codebook size.

By including or configuring the communications manager 1420 in accordance with examples as described herein, the device 1405 may support techniques for HARQ ACK/NACK feedback through codebooks that are adjusted based on carriers and slots that are schedulable at the UE, which may enhance UE operation by reducing power consumption and processing resource usage, and also provide for more efficient usage of communications resources associated with reduced overhead for feedback transmissions.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of feedback techniques for unscheduled carriers in wireless communications as described herein, or the at least one processor 1435 and the at least one memory 1425 may be otherwise configured to, individually or collectively, perform or support such operations.

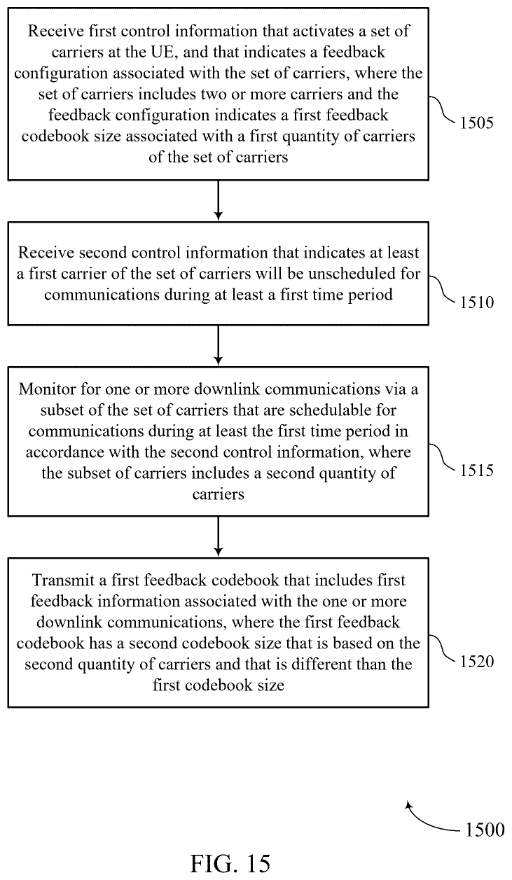

FIG. 15 shows a flowchart illustrating a method 1500 that supports feedback techniques for unscheduled carriers in wireless communications in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving first control information that activates a set of carriers at the UE, and that indicates a feedback configuration associated with the set of carriers, where the set of carriers includes two or more carriers and the feedback configuration indicates a first feedback codebook size associated with a first quantity of carriers of the set of carriers. The operations of 1505 may be performed in accordance with examples as disclosed herein. In some examples, aspects of the operations of 1505 may be performed by a configuration component 925 as described with reference to FIG. 9.

At 1510, the method may include receiving second control information that indicates at least a first carrier of the set of carriers will be unscheduled for communications during at least a first time period. The operations of 1510 may be performed in accordance with examples as disclosed herein. In some examples, aspects of the operations of 1510 may be performed by a scheduling component 930 as described with reference to FIG. 9.

At 1515, the method may include monitoring for one or more downlink communications via a subset of the set of carriers that are schedulable for communications during at least the first time period in accordance with the second control information, where the subset of carriers includes a second quantity of carriers. The operations of 1515 may be performed in accordance with examples as disclosed herein. In some examples, aspects of the operations of 1515 may be performed by a downlink reception component 935 as described with reference to FIG. 9.

At 1520, the method may include transmitting a first feedback codebook that includes first feedback information associated with the one or more downlink communications, where the first feedback codebook has a second codebook size that is based on the second quantity of carriers and that is different than the first codebook size. The operations of 1520 may be performed in accordance with examples as disclosed herein. In some examples, aspects of the operations of 1520 may be performed by a feedback component 940 as described with reference to FIG. 9.

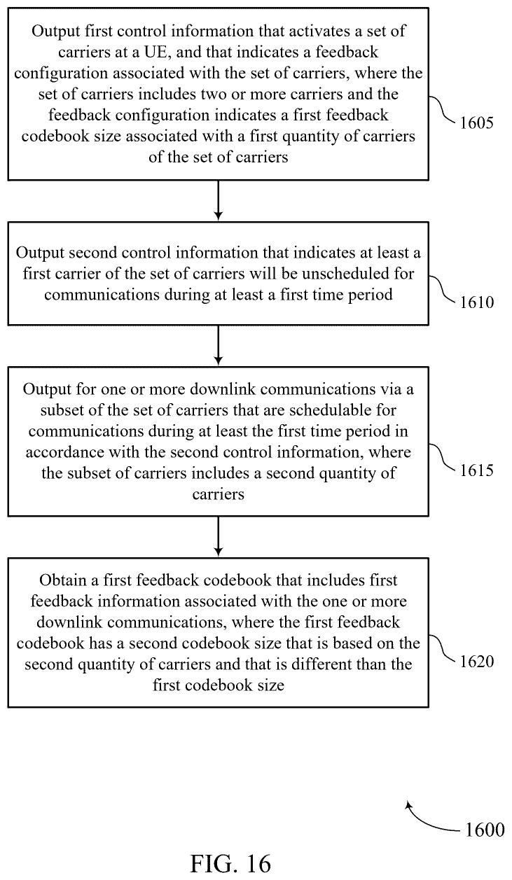

FIG. 16 shows a flowchart illustrating a method 1600 that supports feedback techniques for unscheduled carriers in wireless communications in accordance with one or more aspects of the present disclosure. The operations of the method 1600 may be implemented by a network entity or its components as described herein. For example, the operations of the method 1600 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1605, the method may include outputting first control information that activates a set of carriers at a UE, and that indicates a feedback configuration associated with the set of carriers, where the set of carriers includes two or more carriers and the feedback configuration indicates a first feedback codebook size associated with a first quantity of carriers of the set of carriers. The operations of 1605 may be performed in accordance with examples as disclosed herein. In some examples, aspects of the operations of 1605 may be performed by a configuration component 1325 as described with reference to FIG. 13.

At 1610, the method may include outputting second control information that indicates at least a first carrier of the set of carriers will be unscheduled for communications during at least a first time period. The operations of 1610 may be performed in accordance with examples as disclosed herein. In some examples, aspects of the operations of 1610 may be performed by a scheduling component 1330 as described with reference to FIG. 13.

At 1615, the method may include outputting for one or more downlink communications via a subset of the set of carriers that are schedulable for communications during at least the first time period in accordance with the second control information, where the subset of carriers includes a second quantity of carriers. The operations of 1615 may be performed in accordance with examples as disclosed herein. In some examples, aspects of the operations of 1615 may be performed by a downlink transmission component 1335 as described with reference to FIG. 13.

At 1620, the method may include obtaining a first feedback codebook that includes first feedback information associated with the one or more downlink communications, where the first feedback codebook has a second codebook size that is based on the second quantity of carriers and that is different than the first codebook size. The operations of 1620 may be performed in accordance with examples as disclosed herein. In some examples, aspects of the operations of 1620 may be performed by a feedback component 1340 as described with reference to FIG. 13.

The following provides an overview of aspects of the present disclosure:

Aspect 1: A method for wireless communications at a UE, comprising: receiving first control information that activates a set of carriers at the UE, and that indicates a feedback configuration associated with the set of carriers, wherein the set of carriers includes two or more carriers and the feedback configuration indicates a first feedback codebook size associated with a first quantity of carriers of the set of carriers; receiving second control information that indicates at least a first carrier of the set of carriers will be unscheduled for communications during at least a first time period; monitoring for one or more downlink communications via a subset of the set of carriers that are schedulable for communications during at least the first time period in accordance with the second control information, wherein the subset of carriers includes a second quantity of carriers; and transmitting a first feedback codebook that includes first feedback information associated with the one or more downlink communications, wherein the first feedback codebook has a second codebook size that is based at least in part on the second quantity of carriers and that is different than the first codebook size.

Aspect 2: The method of aspect 1, wherein the receiving the second control information comprises: receiving RRC signaling or a medium access control (MAC) control element that indicates that at least the first carrier of the set of carriers will be unscheduled for communications until a subsequent control information transmission provides an indication that at least the first carrier is schedulable.

Aspect 3: The method of any of aspects 1 through 2, wherein the second codebook size is based at least in part on the second quantity of carriers and a quantity of slots within a feedback time duration indicated in the feedback configuration.

Aspect 4: The method of any of aspects 1 through 3, wherein the feedback configuration indicates a feedback codebook that has a fixed quantity of bits.

Aspect 5: The method of any of aspects 1 through 4, wherein the first control information further indicates a first feedback timing information associated with a quantity of slots between a downlink data slot and an uplink slot that includes feedback information, and the second control information further indicates an update to the first feedback timing information.

Aspect 6: The method of aspect 5, wherein the first feedback timing information includes a set of downlink-data-to-uplink-acknowledgment values, and the second control information indicates that one or more of the downlink-data-to-uplink-acknowledgment values are not used for determining the first feedback information.

Aspect 7: The method of any of aspects 1 through 6, wherein the first feedback codebook is transmitted in a first uplink slot and the feedback information is associated with the one or more downlink communications within a feedback window prior to the first uplink slot, and wherein the second control information further indicates an update to the feedback window.

Aspect 8: The method of any of aspects 1 through 7, wherein the first feedback information is associated with the subset of carriers, and one or more subsequent feedback codebooks include subsequent feedback information associated with a different quantity of carriers than the second quantity of carriers in accordance with subsequent control information that indicates at least the first carrier of the set of carriers is schedulable for communications during a subsequent time period, or that at least a second carrier of the set of carriers will be unscheduled during the subsequent time period.

Aspect 9: The method of any of aspects 1 through 8, wherein the feedback configuration includes a feedback time window associated with each carrier of the set of carriers, and a feedback time window associated with each carrier of the subset of carriers is based at least in part on a set of slots in which a corresponding carrier can be scheduled for downlink communications.

Aspect 10: The method of any of aspects 1 through 9, wherein the first control information further indicates a first uplink resource for transmission of feedback information that is associated with the set of carriers, and a second uplink resource for transmission of feedback information that is associated with the subset of carriers, and the second control information includes an indication of which of the first uplink resource or the second uplink resource is to be used for transmission of the first feedback information.

Aspect 11: The method of any of aspects 1 through 10, wherein the first control information further indicates a plurality of frequency segments that are each associated with one or more carriers of the set of carriers, and the second control information indicates a quantity of the plurality of frequency segments that will be unscheduled for communications during at least the first time period.

Aspect 12: The method of aspect 11, further comprising: bundling feedback information for one or more carriers that are included in a remaining quantity of the plurality of frequency segments.

Aspect 13: The method of aspect 12, wherein the bundling the feedback information comprises: including feedback information associated with each slot of a set of downlink slots associated with a single carrier when the single carrier is included in a remaining quantity of the plurality of frequency segments; and encoding feedback information from two or more carriers for each slot of the set of downlink slots when two or more carriers are included in the remaining quantity of the plurality of frequency segments, wherein the encoded feedback information indicates feedback information for each of the two or more carriers that are schedulable in the remaining quantity of the plurality of frequency segments.

Aspect 14: A method for wireless communications at a network entity, comprising: outputting first control information that activates a set of carriers at a UE, and that indicates a feedback configuration associated with the set of carriers, wherein the set of carriers includes two or more carriers and the feedback configuration indicates a first feedback codebook size associated with a first quantity of carriers of the set of carriers; outputting second control information that indicates at least a first carrier of the set of carriers will be unscheduled for communications during at least a first time period; outputting for one or more downlink communications via a subset of the set of carriers that are schedulable for communications during at least the first time period in accordance with the second control information, wherein the subset of carriers includes a second quantity of carriers; and obtaining a first feedback codebook that includes first feedback information associated with the one or more downlink communications, wherein the first feedback codebook has a second codebook size that is based at least in part on the second quantity of carriers and that is different than the first codebook size.

Aspect 15: The method of aspect 14, wherein the outputting the second control information comprises: outputting RRC signaling or a medium access control (MAC) control element that indicates that at least the first carrier of the set of carriers will be unscheduled for communications until a subsequent control information transmission provides an indication that at least the first carrier is schedulable.

Aspect 16: The method of any of aspects 14 through 15, wherein the second codebook size is based at least in part on the second quantity of carriers and a quantity of slots within a feedback time duration indicated in the feedback configuration.

Aspect 17: The method of any of aspects 14 through 16, wherein the feedback configuration indicates a feedback codebook that has a fixed quantity of bits.

Aspect 18: The method of any of aspects 14 through 17, wherein the first control information further indicates a first feedback timing information associated with a quantity of slots between a downlink data slot and an uplink slot that includes feedback information, and the second control information further indicates an update to the first feedback timing information.

Aspect 19: The method of aspect 18, wherein the first feedback timing information includes a set of downlink-data-to-uplink-acknowledgment values, and the second control information indicates that one or more of the downlink-data-to-uplink-acknowledgment values are not used for determining the first feedback information.

Aspect 20: The method of any of aspects 14 through 19, wherein the first feedback codebook is provided in a first uplink slot and the feedback information is associated with the one or more downlink communications within a feedback window prior to the first uplink slot, and wherein the second control information further indicates an update to the feedback window.

Aspect 21: The method of any of aspects 14 through 20, wherein the first feedback information is associated with the subset of carriers, and one or more subsequent feedback codebooks include subsequent feedback information associated with a different quantity of carriers than the second quantity of carriers in accordance with subsequent control information that indicates at least the first carrier of the set of carriers is schedulable for communications during a subsequent time period, or that at least a second carrier of the set of carriers will be unscheduled during the subsequent time period.

Aspect 22: The method of any of aspects 14 through 21, wherein the feedback configuration includes a feedback time window associated with each carrier of the set of carriers, and a feedback time window associated with each carrier of the subset of carriers is based at least in part on a set of slots in which a corresponding carrier can be scheduled for downlink communications.

Aspect 23: The method of any of aspects 14 through 22, wherein the first control information further indicates a first uplink resource for transmission of feedback information that is associated with the set of carriers, and a second uplink resource for transmission of feedback information that is associated with the subset of carriers, and the second control information includes an indication of which of the first uplink resource or the second uplink resource is to be used for transmission of the first feedback information.

Aspect 24: The method of any of aspects 14 through 23, wherein the first control information further indicates a plurality of frequency segments that are each associated with one or more carriers of the set of carriers, and the second control information indicates a quantity of the plurality of frequency segments that will be unscheduled for communications during at least the first time period.

Aspect 25: The method of aspect 24, wherein the first feedback information includes bundled feedback for one or more carriers that are included in a remaining quantity of the plurality of frequency segments.

Aspect 26: The method of aspect 25, wherein the bundled feedback includes a feedback indication associated with each slot of a set of downlink slots associated with a single carrier when the single carrier is included in a remaining quantity of the plurality of frequency segments; and the bundled feedback includes encoded feedback information from two or more carriers for each slot of the set of downlink slots when two or more carriers are included in the remaining quantity of the plurality of frequency segments, wherein the encoded feedback information indicates feedback information for each of the two or more carriers that are schedulable in the remaining quantity of the plurality of frequency segments.

Aspect 27: A UE for wireless communications, comprising one or more memories storing processor-executable code, and one or more processors coupled with the one or more memories and individually or collectively operable to execute the code to cause the UE to perform a method of any of aspects 1 through 13.

Aspect 28: A UE for wireless communications, comprising at least one means for performing a method of any of aspects 1 through 13.

Aspect 29: A non-transitory computer-readable medium storing code for wireless communications, the code comprising instructions executable by one or more processors to perform a method of any of aspects 1 through 13.

Aspect 30: A network entity for wireless communications, comprising one or more memories storing processor-executable code, and one or more processors coupled with the one or more memories and individually or collectively operable to execute the code to cause the network entity to perform a method of any of aspects 14 through 26.

Aspect 31: A network entity for wireless communications, comprising at least one means for performing a method of any of aspects 14 through 26.

Aspect 32: A non-transitory computer-readable medium storing code for wireless communications, the code comprising instructions executable by one or more processors to perform a method of any of aspects 14 through 26.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive first control information that activates a set of carriers at the UE, and that indicates a feedback configuration associated with the set of carriers, wherein the set of carriers includes two or more carriers and the feedback configuration indicates a first feedback codebook size associated with a first quantity of carriers of the set of carriers;
receive second control information that indicates at least a first carrier of the set of carriers will be unscheduled for communications during at least a first time period;
monitor for one or more downlink communications via a subset of the set of carriers that are schedulable for communications during at least the first time period in accordance with the second control information, wherein the subset of carriers includes a second quantity of carriers; and
transmit a first feedback codebook that includes first feedback information associated with the one or more downlink communications, wherein the first feedback codebook has a second codebook size that is based at least in part on the second quantity of carriers and that is different than the first codebook size.

2. The UE of claim 1, wherein, to receive the second control information, the one or more processors are individually or collectively operable to execute the code to cause the UE to:
receive radio resource control (RRC) signaling or a medium access control (MAC) control element that indicates that at least the first carrier of the set of carriers will be unscheduled for communications until a subsequent control information transmission provides an indication that at least the first carrier is schedulable.

3. The UE of claim 1, wherein the second codebook size is based at least in part on the second quantity of carriers and a quantity of slots within a feedback time duration indicated in the feedback configuration.

4. The UE of claim 1, wherein the feedback configuration indicates a feedback codebook that has a fixed quantity of bits.

5. The UE of claim 1, wherein the first control information further indicates a first feedback timing information associated with a quantity of slots between a downlink data slot and an uplink slot that includes feedback information, and the second control information further indicates an update to the first feedback timing information.

6. The UE of claim 5, wherein the first feedback timing information includes a set of downlink-data-to-uplink-acknowledgment values, and the second control information indicates that one or more of the downlink-data-to-uplink-acknowledgment values are not used for determining the first feedback information.

7. The UE of claim 1, wherein the first feedback codebook is transmitted in a first uplink slot and the feedback information is associated with the one or more downlink communications within a feedback window prior to the first uplink slot, and wherein the second control information further indicates an update to the feedback window.

8. The UE of claim 1, wherein the first feedback information is associated with the subset of carriers, and one or more subsequent feedback codebooks include subsequent feedback information associated with a different quantity of carriers than the second quantity of carriers in accordance with subsequent control information that indicates at least the first carrier of the set of carriers is schedulable for communications during a subsequent time period, or that at least a second carrier of the set of carriers will be unscheduled during the subsequent time period.

9. The UE of claim 1, wherein the feedback configuration includes a feedback time window associated with each carrier of the set of carriers, and a feedback time window associated with each carrier of the subset of carriers is based at least in part on a set of slots in which a corresponding carrier can be scheduled for downlink communications.

10. The UE of claim 1, wherein:
the first control information further indicates a first uplink resource for transmission of feedback information that is associated with the set of carriers, and a second uplink resource for transmission of feedback information that is associated with the subset of carriers, and
the second control information includes an indication of which of the first uplink resource or the second uplink resource is to be used for transmission of the first feedback information.

11. The UE of claim 1, wherein the first control information further indicates a plurality of frequency segments that are each associated with one or more carriers of the set of carriers, and the second control information indicates a quantity of the plurality of frequency segments that will be unscheduled for communications during at least the first time period.

12. The UE of claim 11, wherein the one or more processors are individually or collectively further operable to execute the code to cause the UE to:
bundle feedback information for one or more carriers that are included in a remaining quantity of the plurality of frequency segments.

13. The UE of claim 12, wherein, to bundle the feedback information, the one or more processors are individually or collectively operable to execute the code to cause the UE to:
include feedback information associated with each slot of a set of downlink slots associated with a single carrier when the single carrier is included in a remaining quantity of the plurality of frequency segments; and
encode feedback information from two or more carriers for each slot of the set of downlink slots when two or more carriers are included in the remaining quantity of the plurality of frequency segments, wherein the encoded feedback information indicates feedback information for each of the two or more carriers that are schedulable in the remaining quantity of the plurality of frequency segments.

14. A network entity, comprising:
one or more memories storing processor-executable code; and
one or more processors coupled with the one or more memories and individually or collectively operable to execute the code to cause the network entity to:
output first control information that activates a set of carriers at a user equipment (UE), and that indicates a feedback configuration associated with the set of carriers, wherein the set of carriers includes two or more carriers and the feedback configuration indicates a first feedback codebook size associated with a first quantity of carriers of the set of carriers;
output second control information that indicates at least a first carrier of the set of carriers will be unscheduled for communications during at least a first time period;
output for one or more downlink communications via a subset of the set of carriers that are schedulable for communications during at least the first time period in accordance with the second control information, wherein the subset of carriers includes a second quantity of carriers; and
obtain a first feedback codebook that includes first feedback information associated with the one or more downlink communications, wherein the first feedback codebook has a second codebook size that is based at least in part on the second quantity of carriers and that is different than the first codebook size.

15. The network entity of claim 14, wherein, to output the second control information, the one or more processors are individually or collectively operable to execute the code to cause the network entity to:
output radio resource control (RRC) signaling or a medium access control (MAC) control element that indicates that at least the first carrier of the set of carriers will be unscheduled for communications until a subsequent control information transmission provides an indication that at least the first carrier is schedulable.

16. The network entity of claim 14, wherein the second codebook size is based at least in part on the second quantity of carriers and a quantity of slots within a feedback time duration indicated in the feedback configuration.

17. The network entity of claim 14, wherein the feedback configuration indicates a feedback codebook that has a fixed quantity of bits.

18. The network entity of claim 14, wherein the first control information further indicates a first feedback timing information associated with a quantity of slots between a downlink data slot and an uplink slot that includes feedback information, and the second control information further indicates an update to the first feedback timing information.

19. The network entity of claim 14, wherein the first feedback codebook is provided in a first uplink slot and the feedback information is associated with the one or more downlink communications within a feedback window prior to the first uplink slot, and wherein the second control information further indicates an update to the feedback window.

20. The network entity of claim 14, wherein the first feedback information is associated with the subset of carriers, and one or more subsequent feedback codebooks include subsequent feedback information associated with a different quantity of carriers than the second quantity of carriers in accordance with subsequent control information that indicates at least the first carrier of the set of carriers is schedulable for communications during a subsequent time period, or that at least a second carrier of the set of carriers will be unscheduled during the subsequent time period.

21. The network entity of claim 14, wherein the feedback configuration includes a feedback time window associated with each carrier of the set of carriers, and a feedback time window associated with each carrier of the subset of carriers is based at least in part on a set of slots in which a corresponding carrier can be scheduled for downlink communications.

22. The network entity of claim 14, wherein:
the first control information further indicates a first uplink resource for transmission of feedback information that is associated with the set of carriers, and a second uplink resource for transmission of feedback information that is associated with the subset of carriers, and
the second control information includes an indication of which of the first uplink resource or the second uplink resource is to be used for transmission of the first feedback information.

23. The network entity of claim 14, wherein the first control information further indicates a plurality of frequency segments that are each associated with one or more carriers of the set of carriers, and the second control information indicates a quantity of the plurality of frequency segments that will be unscheduled for communications during at least the first time period.

24. A method for wireless communications at a user equipment (UE), comprising:
receiving first control information that activates a set of carriers at the UE, and that indicates a feedback configuration associated with the set of carriers, wherein the set of carriers includes two or more carriers and the feedback configuration indicates a first feedback codebook size associated with a first quantity of carriers of the set of carriers;
receiving second control information that indicates at least a first carrier of the set of carriers will be unscheduled for communications during at least a first time period;
monitoring for one or more downlink communications via a subset of the set of carriers that are schedulable for communications during at least the first time period in accordance with the second control information, wherein the subset of carriers includes a second quantity of carriers; and
transmitting a first feedback codebook that includes first feedback information associated with the one or more downlink communications, wherein the first feedback codebook has a second codebook size that is based at least in part on the second quantity of carriers and that is different than the first codebook size.

25. The method of claim 24, wherein the second codebook size is based at least in part on the second quantity of carriers and a quantity of slots within a feedback time duration indicated in the feedback configuration.

26. The method of claim 24, wherein the first control information further indicates a first feedback timing information associated with a quantity of slots between a downlink data slot and an uplink slot that includes feedback information, and the second control information further indicates an update to the first feedback timing information.

27. The method of claim 26, wherein the first feedback timing information includes a set of downlink-data-to-uplink-acknowledgment values, and the second control information indicates that one or more of the downlink-data-to-uplink-acknowledgment values are not used for determining the first feedback information.

28. A method for wireless communications at a network entity, comprising:
outputting first control information that activates a set of carriers at a user equipment (UE), and that indicates a feedback configuration associated with the set of carriers, wherein the set of carriers includes two or more carriers and the feedback configuration indicates a first feedback codebook size associated with a first quantity of carriers of the set of carriers;
outputting second control information that indicates at least a first carrier of the set of carriers will be unscheduled for communications during at least a first time period;
outputting for one or more downlink communications via a subset of the set of carriers that are schedulable for communications during at least the first time period in accordance with the second control information, wherein the subset of carriers includes a second quantity of carriers; and
obtaining a first feedback codebook that includes first feedback information associated with the one or more downlink communications, wherein the first feedback codebook has a second codebook size that is based at least in part on the second quantity of carriers and that is different than the first codebook size.

29. The method of claim 28, wherein the second codebook size is based at least in part on the second quantity of carriers and a quantity of slots within a feedback time duration indicated in the feedback configuration.

30. The method of claim 28, wherein the first control information further indicates a first feedback timing information associated with a quantity of slots between a downlink data slot and an uplink slot that includes feedback information, and the second control information further indicates an update to the first feedback timing information.
